(19) United States
(12) Patent Application Publication
(10) Pub. No.: US 2003/0079681 A1
(43) Pub. Date: May 1, 2003

(54) Adjustable guide

(75) Inventor: David Hardy, Duluth, GA (US)

Correspondence Address: Wood, Herron & Evans, L.L.P., Attention: David H. Brinkman, 2700 Carew Tower, Cincinnati, OH, 45202, US

(73) Assignee: Nordson Corporation

(21) Appl. No.: 10/021,400

(22) Filed: Oct. 30, 2001

(51) Int. Cl. B05C 5/00

(52) U.S. Cl. 118/300

(57) ABSTRACT

A guide and method for guiding spaced apart elongated strands in a liquid dispensing environment. The guide includes discrete strand guide members that guide the strands in alignment with dispensing outlets of a liquid dispenser so that beads of adhesive are captured on the strands. The spacing between the strand guide members can be readily changed to match the spacing of the dispensing outlets.

### FIELD OF THE INVENTION

The present invention relates generally to liquid dispensing systems for dispensing liquid material onto elongated strands and, more particularly, to a guide for use with such a liquid dispensing system to guide the strands in spaced apart relationship during the liquid dispensing process.

### BACKGROUND OF THE INVENTION

In the manufacture of disposable diapers, adult incontinence pads and other hygienic articles, it is often desirable to provide a stretchable portion on the article, such as a waist band or leg, so that a relatively tight fluid seal between the article and the body can be formed. Generally, these stretchable portions are formed by bonding stretched elastic strands directly to the fabric with adhesive so that as the strands contract, the fabric is bunched together to form stretchable regions in the fabric. Alternatively, the stretchable strands are bonded to a web of waistband or leg cuff material which is then bonded to selected areas of the article to form stretchable regions in the fabric.

The strands are bonded to the fabric by guiding the stands in spaced apart relationship toward dispensing outlets of a liquid adhesive dispenser. The dispensing outlets are provided on a pattern die of the liquid dispenser and are disposed above and spaced from the elongated strands as the strands travel in the machine direction. The liquid dispenser has a guide wheel positioned upstream of the dispensing outlets that guides each strand in registry with the dispensing axis of an outlet so that each outlet dispenses a continuous bead of adhesive onto one of the strands. Each bead of adhesive may be dispensed in a swirl, cross-stitch or other pattern toward the strand so that the pattern of the dispensed bead expands in the cross-machine direction during its flight toward the strand. The beads of adhesive contact and wrap around the strands to provide an adhesive coating around the circumference of the strands prior to their attachment to the fabric.

In the past, the guide wheel has comprised a single wheel, made of metal or other suitable material, that is machined with spaced circumferential grooves to guide the strands in alignment with the dispensing outlets of the liquid dispenser. The grooves are machined into the guide wheel so that the spacing of the grooves corresponds to the spacing between the dispensing outlets of the pattern die. The spacing of the circumferential grooves must be accurate relative to the dispensing axes of the outlets to insure that the adhesive beads are dispensed symmetrically onto the strands. Otherwise, the adhesive may not fully wrap around the strands resulting in the strands not properly adhering or laminating to the fabric.

One drawback or shortcoming of known guide wheels is that the grooves must be machined with a spacing that matches the particular dispensing outlet spacing of the pattern die. As the spacing between the dispensing outlets is changed with a change in the pattern die, the guide wheel must be removed and replaced with a different guide wheel having a groove spacing that matches the particular pattern die in use. Therefore, an inventory of guide wheels having different groove configurations must be maintained and properly matched with the pattern die in use. Furthermore, identical pattern dies, i.e., pattern dies having identical spacing between the dispensing outlets, do not necessarily generate the same spacing between the dispensed adhesive beads. This characteristic of pattern dies further complicates the process of matching the groove spacing of a guide wheel with a particular pattern die so that each strand is properly coated with an adhesive bead.

Accordingly, there is a need for a guide that improves the positioning of elongated strands relative to dispensing outlets of a liquid dispenser so that each strand is properly coated with a bead of adhesive prior to attachment to a fabric.

### SUMMARY OF THE INVENTION

The present invention overcomes the foregoing and other shortcomings and drawbacks of guides and methods heretofore known for positioning elongated strands in a liquid dispensing environment. While the invention will be described in connection with certain embodiments, it will be understood that the invention is not limited to these embodiments. On the contrary, the invention includes all alternatives, modifications and equivalents as may be included within the spirit and scope of the present invention.

A guide in accordance with the principles of the present invention, such as a rotatable guide wheel in one embodiment, is adapted to be mounted on a shaft supported by a liquid dispenser for guiding a plurality of spaced apart elongated strands toward a plurality of outlets capable of dispensing liquid material onto the strands. The guide wheel includes a plurality of discrete strand guide members supported in spaced apart relationship on the shaft for guiding the strands toward the dispensing outlets with a predetermined spacing between the strands. Each strand guide member may comprise an annular disk having a circumferential groove formed therein for engaging and guiding a strand toward a dispensing outlet.

In one embodiment of the present invention, the guide wheel includes a support sleeve having a pair of bushings mounted at its opposite ends for supporting the guide wheel for rotation on the shaft. The discrete strand guide members are supported in spaced apart relationship on the support sleeve. The guide wheel further includes a plurality of spacer members positioned intermediate the strand guide members for accurately spacing the strand guide members on the support sleeve. Each spacer member may comprise an annular shim or washer having a predetermined width along an axis of the support sleeve for spacing two adjacent strand guide members to provide a predetermined spacing between a pair of the strands.

The spacer members are interchangeable with spacer members having a different predetermined width to vary the spacing between the strand guide members and thereby vary the predetermined spacing between the strands. In this way, the strand guide members are variably positionable on the support sleeve so that the guide wheel can be readily adjusted or reconfigured to vary the spacing between the strands to match the dispensing characteristics of a particular pattern die.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of a liquid dispensing system including a guide wheel for guiding elongated strands toward dispensing outlets of the dispensing system in accordance with the principles of the present invention;

FIG. 1A is an elevational view, partially broken away, taken along line 1A-1A of FIG. 1; and

FIG. 2 is a partial disassembled perspective view of the liquid dispensing system shown in FIG. 1, illustrating mounting of the guide wheel to the dispensing system in accordance with one embodiment of the present invention.

### DETAILED DESCRIPTION OF THE PREFERRED EMBODIMENT

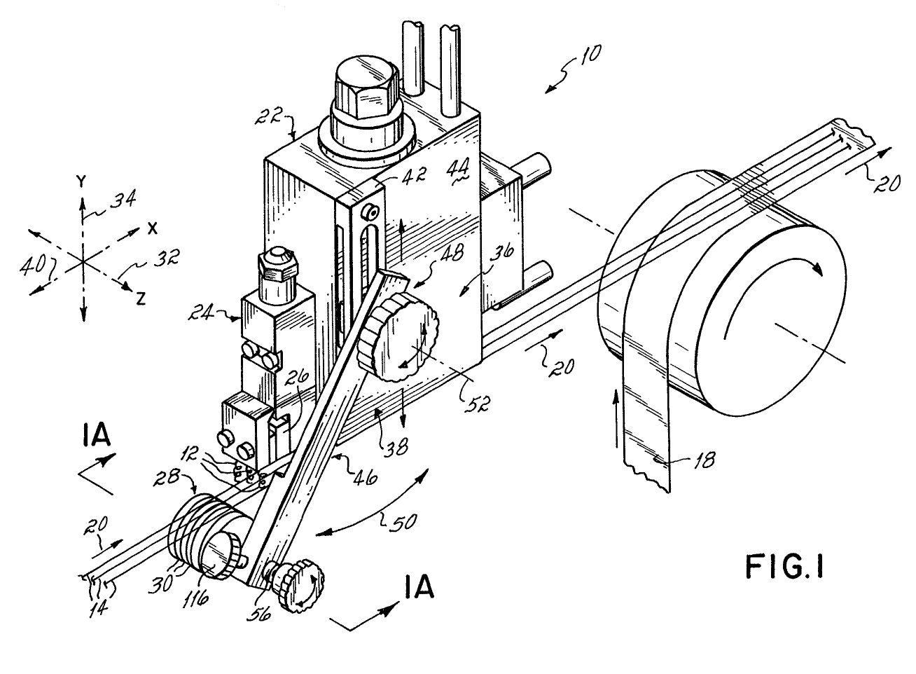

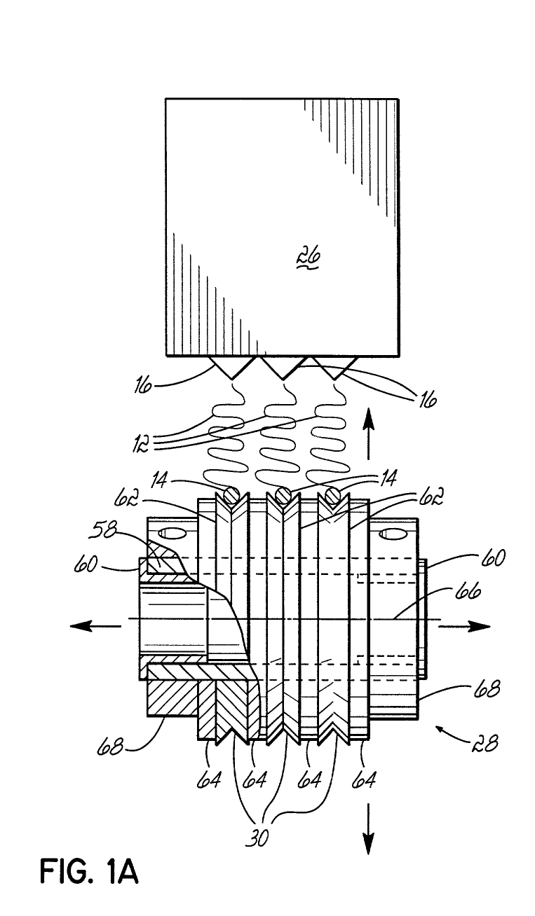

With reference to the Figures, and to FIG. 1 in particular, a liquid dispensing system 10 is shown in accordance with the principles of the present invention for dispensing beads of liquid material, such as beads 12 of hot melt adhesive, onto elongated strands 14, such as strands of elastic or non-elastic material. As will described in greater detail below, each of the strands 14 travels along a travel path spaced from and aligned with a dispensing axis of a respective dispensing outlet 16 (FIG. 1A) so that a bead 12 of adhesive is fully or at least partially captured on each strand 14 while each strand 14 is separate from a substrate 18, such as a web of waist band or leg cuff material or fabric used in the manufacture of diapers (not shown) for example. The coated elastic strands 14, which may comprise elastic strands of LYCRA XA™ Spandex, a synthetic stranded product manufactured by DuPont, or other stranded elastic products such as threaded natural rubber by way of example, are thereafter bonded to the substrate 18 substantially entirely along their respective axial lengths so that as the strands 14 contract, the web 18 is bunched together to form the stretchable waist bands, leg cuffs or other stretchable fabrics for a variety of products. The term “strand” or similar terms used in the present specification are meant to include both elastic and non-elastic materials.

Further referring to FIG. 1, the strands 14 run continuously in a machine direction (MD), represented by arrows 20. The liquid dispensing system 10 is operable to receive hot melt adhesive from a liquid adhesive source (not shown), and to dispense the beads 12 of adhesive toward the strands 14 from the respective dispensing outlets 16. While three (3) parallel elongated strands 14 are shown being coated by beads 12 of material dispensed from three (3) liquid dispensing outlets 16 (FIG. 1A), one or multiple strands 14 can be used and the adhesive can be dispensed from one or multiple dispensing outlets 16.

The liquid dispensing system 10 includes an adhesive and air manifold 22 connected to a liquid dispensing module 24 in a manner known to those of ordinary skill in the art. The liquid dispensing module 24 may include an internal valve (not shown) for controlling the flow of adhesive through the dispensing outlets 16, and has a pattern die 26 (FIG. 1) connected at a remote end of the dispensing module 24 that controls the pattern of each adhesive bead 12 dispensed from a respective outlet 16.

The pattern die 26 may comprise a SUMMit™ pattern die commercially available from Nordson Corporation of Westlake, Ohio, assignee of the present invention, and fully described in detail in U.S. Ser. No. 09/571,703, filed May 15, 2000 and U.S. Ser. No. 09/571,601, filed May 15, 2001, the disclosures of which are hereby incorporated herein by reference in their entireties. By way of background, the SUMMit™ pattern die is configured with multiple dispensing outlets 16 arranged along the width of the pattern die 26, with each liquid dispensing outlet 16 having four (4) air outlets (not shown) arranged around the dispensing outlet 16 forming four (4) radially tangential air jets (not shown) that spin the dispensed bead 12 of adhesive in a generally symmetrical spiral pattern toward the strand 14. The operating characteristics of the liquid dispensing system 10, including the adhesive pressure, air pressure, distance from the dispensing outlet 16 to the strand 14, can all be varied to control the extent of the adhesive wrap around and to control the amount of adhesive captured by the strand 14. The adhesive bead 12 is dispensed toward the strand 14 in a generally symmetrical pattern relative to the axis of the outlet 16 so that the pattern expands in the cross-machine direction (CD). The strand 14 travels in the machine direction (MD) so that at least a portion of the bead 12 crosses the travel path of the strand 14 and attaches thereto.

As shown in FIGS. 1 and 1A, the strands 14 are guided along their respective travel paths in the machine direction (MD) by a guide 28, such as a rotatable guide wheel in accordance with one embodiment of the present invention, having circumferential grooves 30 that are operable to guide the stands 14 generally in alignment with the respective dispensing outlets 16 so that the travel path of each strand 14 generally intersects the dispensing axis of a respective one of the dispensing outlets 16, as shown in FIG. 1A. The guide wheel 28 engages and supports the strands 14 upstream of the dispensing outlets 16 and controls the position and spacing of each strand 14 along a Z-axis 32, i.e., the position of each strand 14 in the cross-machine direction (CD) relative to the dispensing axis of a respective dispensing outlet 16, and along a Y-axis 34, i.e., the spacing or distance of each strand 14 from a respective dispensing outlet 16. Accurate positioning and spacing of each stand 14 relative to its respective dispensing outlet 16 along the Y- and Z-axes 34, 32 is critical for achieving a coating of adhesive on each strand 14 that will permit the strand 14 to be bonded substantially entirely along its axial length to the web 18.

For example, if the strands 14 are spaced too far from the dispensing outlets 16 along the Y-axis 34, the dispensed beads 12 will have a pattern width that will cause the beads 12 to significantly overshoot the edges of the strands 14 so that a portion of the dispensed adhesive material may be wasted. Additionally, if each strand 14 is not generally aligned with the dispensing axis of its respective dispensing outlet 16 along the Z-axis 32, the bead 12 will not be applied symmetrically onto the strand 14 so that portions of the strand 14 may not be properly laminated to the web 18.

Referring now to FIG. 1, a guide system 36 is shown for accurately and reliably positioning the elongated strands 14 relative to their respective dispensing outlets 16. Details of the guide system 36 are fully disclosed in U.S. Ser. No. 09/816,522, filed Mar. 23, 2001, the disclosure of which is hereby incorporated herein by reference in its entirety to which the reader is referred. Briefly, the guide system 36 includes a positioning mechanism 38 operatively connected to the adhesive and air manifold 22 and the guide wheel 28 for positioning the guide wheel 28 along three (3) orthogonal axes, namely an X-axis 40 in the machine direction (MD), the Y-axis 34, and the Z-axis 32 in the cross machine direction (CD). The guide system 36 has three (3) degrees of freedom for positioning the guide wheel 28 along the three (3) orthogonal axes 32, 34 and 40. In this way, the positioning mechanism 38 is operable to properly position the guide wheel 28 upstream of the dispensing outlets 16 so that the position of the guided strands 14 relative to the respective dispensing outlets 16 can be accurately and reliably adjusted and controlled.

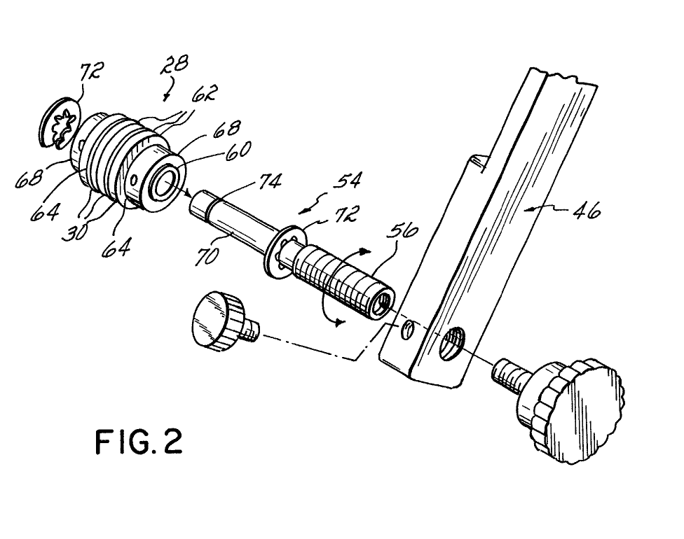

As shown in FIG. 1, the positioning mechanism 38 includes an elongated guide member 42 that is mounted to a side surface 44 of the adhesive and air manifold 22. The positioning mechanism 38 further includes an elongated arm member 46 that is pivotally connected to the guide member 42 through a pivotal connection 48. The pivotal connection 48 permits the arm member 46 to be rotated relative to the guide member 42, as indicated generally by arrow 50 in FIG. 1, about an axis 52 of the pivotal connection 48 (FIG. 1). The pivotal connection 48 is capable of linear movement relative to the guide member 42 along the Y-axis 34. A shaft member 54 is operatively connected to the guide wheel 28 and has a threaded end 56 (FIG. 2) operatively connected to the arm member 46 at a position remote from the pivotal connection 48. The shaft member 54 and guide wheel 28 are mounted to the arm member 46 for linear movement along the Z-axis 32 as fully described in U.S. Ser. No. 09/816,522 previously incorporated herein by reference.

The guide wheel 28 is mounted for rotation on the shaft member 54 so that the guide wheel 28 guides the strands 14 toward the dispensing outlets 16 with a predetermined spacing between the strands 14. In accordance with one embodiment of the present invention, as shown in FIG. 1A, the guide wheel 28 includes a support sleeve 58 having a pair of bushings 60 mounted at its opposite ends for supporting the guide wheel 28 for rotation on the shaft member 54. The guide wheel 28 further includes discrete strand guide members 62 supported in spaced apart relationship on the support sleeve 58 and spacer members 64 positioned intermediate the strand guide members 62 for accurately spacing the strand guide members 62 on the support sleeve 58.

In one embodiment of the present invention, each strand guide member 62 comprises an annular disk made of plastic or other suitable material and having the circumferential groove 30 formed therein for engaging and guiding one of the strands 14 toward a dispensing outlet 16. The strand guide members 62 are spaced along the longitudinal axis 66 (FIG. 1A) of the support sleeve 58 by the spacer members 64 which may comprise annular shims or washers made of metal or other suitable material as shown in FIGS. 1A and 2. Each spacer member 64 has a predetermined width along the axis 66 of the support sleeve 58 for spacing a pair of adjacent strand guide members 62 to provide a predetermined spacing between a pair of strands 14. The spacer members 64 are interchangeable with spacer members having a different predetermined width (not shown) to vary the spacing between the strand guide members 62 and thereby vary the predetermined spacing between the strands 14 as will be appreciated by those of ordinary skill in the art. In this way, the strand guide members 62 are variably positionable on the support sleeve 58 so that the guide wheel 28 can be readily adjusted or reconfigured to vary the spacing between the strands 14.

In use, a predetermined number of strand guide members 62 and spacer members 64 are mounted alternatively on the support sleeve 58 so that the spacer members 64 are mounted intermediate the strand guide members 62. The number of strand guide members 62 corresponds to the number of strands 14 to be coated with adhesive from the dispensing outlets 16. The strand guide members 62 and spacer members 64 are retained on the support sleeve 58 by a pair of retaining collars 68. Each of the retaining collars 68 includes a set screw (not shown) that enables the collars 68 to be positioned and set on the support sleeve 58 to prevent axial movement of the strand guide members 62 and spacer members 64 along axis 66 of the support sleeve 58. The width of each spacer member 64 is chosen for spacing the strand guide members 62 to provide the desired spacing between the strands 14. Once the proper selection of strand guide members 62 and spacer members 64 has been made and set on the support sleeve 58 by the retaining collars 68, the assembled guide wheel 28 is captured on an unthreaded portion 70 of the shaft member 54 by a pair of retaining rings 72 that are retained in a pair of spaced circumferential grooves 74 (one shown in FIG. 2) formed on the unthreaded portion 70 of the shaft member 54. Of course, those of ordinary skill in the art will appreciate that other mounting of the strand guide members 62 and spacer members 64 on the shaft member 54 is possible as well without departing from the spirit and scope of the present invention. In addition, while a guide 28 is shown and described herein as preferably comprising a guide wheel, those of ordinary skill in the art will appreciate that other guide structures capable of guiding the strands 14 toward the dispensing outlets 16 with a predetermined spacing between the strands 14 are possible as well without departing from the spirit and scope of the present invention.

The adjustable guide wheel 28 of the present invention provides many advantages and benefits. Use of the discrete strand guide members 62 and spacer members 64 enables the guide wheel 28 to be adjusted or configured to match a particular dispensing application without the need to machine a new guide wheel. The spacing between the strands 14 can be easily and rapidly changed or adjusted with the adjustable guide wheel 28 of the present invention and nearly infinite adjustment can be accomplished. In this way, the guide wheel 28 of the present invention accurately positions the strands 14 relative to the dispensing outlets 16 so that each strand 14 is properly coated with adhesive prior to attachment to the substrate 18.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

Having described the invention, what is claimed is:

1. A guide mounted on a shaft for guiding a plurality of spaced apart elongated strands toward a plurality of dispensing outlets capable of dispensing liquid material onto the strands, comprising:
a plurality of discrete strand guide members capable of being supported in spaced apart relationship on the shaft for guiding the strands toward the plurality of dispensing outlets with a predetermined spacing between the strands.

2. The guide of claim 1 further comprising a spacer member positioned intermediate two of said strand guide members and having a predetermined width for spacing said two strand guide members on the shaft.

3. The guide of claim 1 wherein each of said strand guide members comprises an annular disk having a circumferential groove for engaging one of said plurality of strands.

4. A guide mounted on a shaft for guiding a plurality of spaced apart elongated strands toward a plurality of dispensing outlets capable of dispensing liquid material onto the strands, comprising:
a support sleeve capable of being supported on the shaft; and
a plurality of discrete strand guide members supported by and variably positionable along the longitudinal axis of said support sleeve for guiding the strands toward the plurality of dispensing outlets with a predetermined spacing between the strands.

5. The guide of claim 4 further comprising a spacer member positioned intermediate two of said strand guide members and having a predetermined width for spacing said two strand guide members on the support sleeve.

6. The guide of claim 4 wherein each of said strand guide members comprises an annular disk having a circumferential groove for engaging one of said plurality of strands.

7. A liquid dispensing system for dispensing liquid onto a plurality of elongated strands, comprising:
a liquid dispenser having a plurality of dispensing outlets capable of dispensing liquid material onto the strands;
a shaft connected to said liquid dispenser; and
a plurality of strand guide members supported in spaced apart relationship on said shaft for guiding the strands toward said plurality of dispensing outlets with a predetermined spacing between the strands.

8. The liquid dispensing system of claim 7 further comprising a spacer member positioned intermediate two of said strand guide members and having a predetermined width for spacing said two strand guide members on said shaft.

9. A method of guiding a plurality of elongated strands toward a plurality of dispensing outlets capable of dispensing liquid material onto the strands, each strand engaging one of a plurality of discrete strand guide members capable of guiding the strands toward the plurality of dispensing outlets, comprising:
supporting the strand guide members in spaced apart relationship; and
guiding the strands with the plurality of strand guide members toward the plurality of dispensing outlets with a predetermined spacing between the strands.

10. The method of claim 9, further comprising the step of:
varying the spacing between the strand guide members to thereby vary the predetermined spacing between the strands.
